(19) United States
(12) Patent Application Publication
(10) Pub. No.: US 2009/0079668 A1
(43) Pub. Date: Mar. 26, 2009

(54) METHOD FOR MEASURING READABILITY OF SCREEN UNDER SUNSHINE

(76) Inventors: Dennis LIU, Taipei City (TW); Pei Chang Ho, Taipei City (TW); Ching-Yi Lin, Taipei City (TW)

Correspondence Address: SINORICA, LLC, 528 FALLSGROVE DRIVE, ROCKVILLE, MD, 20850, US

(21) Appl. No.: 11/859,743

(22) Filed: Sep. 22, 2007

(51) Int. Cl. G09G 3/36

(52) U.S. Cl. 345/30

(57) ABSTRACT

A method for measuring the readability of a screen under sunshine is disclosed. In this method, a first set of basic data of a screen module to be tested under dark room conditions is measured. Next, a second set of basic data of the screen module under simulated sunshine conditions is measured. A first screen readability interval data and a second screen readability interval data are then obtained according to the first set of basic data and the second set of basic data. Finally, the first screen readability interval data and the second screen readability interval data are used to determine whether or not the screen module can be clearly read under sunshine. These readability interval data can be used as a basis for leave-factory quality inspection of screens.

### BACKGROUND OF THE INVENTION

1. Field of the invention

The present invention relates to a method for measuring the readability of a screen under sunshine and, more particularly, to a method making use of a sunshine simulation manner to simulate a sunshine environment in order to measure the readability of a screen.

2. Description of Related Art

Because any color light can be obtained by mixing the three primary colors of light—red (R), green (G) and blue (B), the simplest method for measuring whether an LCD screen an LCD screen has bright dots in the prior art comprises the following steps:

The LCD screen is first set to a blue screen to check whether there is any bright dot or dark dot. The LCD screen is then set to a green screen to check whether there is any bright dot or dark dot. Next, the LCD screen is set to a red screen to check whether there is any bright dot or dark dot. Subsequently, the LCD screen is set to a white screen to check whether there is any bright dot or dark dot. Finally, the LCD screen is set to a black screen to check whether there is any bright dot or dark dot.

The above measurement method, however, can only be used in the inspection of bright dots. Moreover, because most existent LCD screens are used indoors, the quality control units mainly demand that LCD screens conform to the brightness of indoor light sources when performing leave-factory inspection of LCD screens.

When LCD screens are verified to be OK using the above measurement standard, some of them may not be clearly read when put under sunshine. The reason is that powerful light of the sun makes human eyes unable to effectively discriminate texts on an LCD screen. In this situation, LCD screens seem to temporarily malfunction and cannot play their proper functions.

Accordingly, the present invention aims to propose a method for measuring the readability of a screen under sunshine to solve the above problems in the prior art.

### SUMMARY OF THE INVENTION

A primary object of the present invention is to provide a method for measuring the readability of a screen under sunshine in order to avoid the problem that texts on a screen cannot be discriminated under sunshine.

To achieve the above object, the present invention provides a method for measuring the readability of a screen under sunshine. This method comprises the following steps. A first set of basic data of a screen module to be tested under dark room conditions is measured. A second set of basic data of the screen module under simulated sunshine conditions is then measured. The allowable range in which the screen module is still readable under sunshine is also examined to cope with the problem that texts on a screen cannot be discriminated under sunshine because of too powerful light. Next, the first set of basic data and the second set of basic data are used to obtain a first screen readability interval data and a second screen readability interval data. Finally, the first screen readability interval data and the second screen readability interval data are used to determine whether or not the screen module can be clearly read under sunshine. These readability interval data can be used as a basis for leave-factory quality inspection of screens.

### BRIEF DESCRIPTION OF THE DRAWINGS

The various objects and advantages of the present invention will be more readily understood from the following detailed description when read in conjunction with the appended drawing, in which:

FIG. 1 is a flowchart of the method for measuring the readability of a screen under sunshine of the present invention;

FIG. 2 is a table showing measured data of color bars under dark room conditions and simulated sunshine conditions of the present invention;

FIG. 3 is a table showing measured data of patterns under dark room conditions and simulated sunshine conditions of the present invention;

FIG. 4 is a graph of the measured data of color bars under dark room conditions and simulated sunshine conditions of the present invention;

FIG. 5 is a graph of the measured data of patterns under dark room conditions and simulated sunshine conditions of the present invention; and

FIG. 6 is a graph of the contrast ratio under dark room conditions and simulated sunshine conditions of the present invention.

### DETAILED DESCRIPTION OF THE PREFERRED EMBODIMENTS

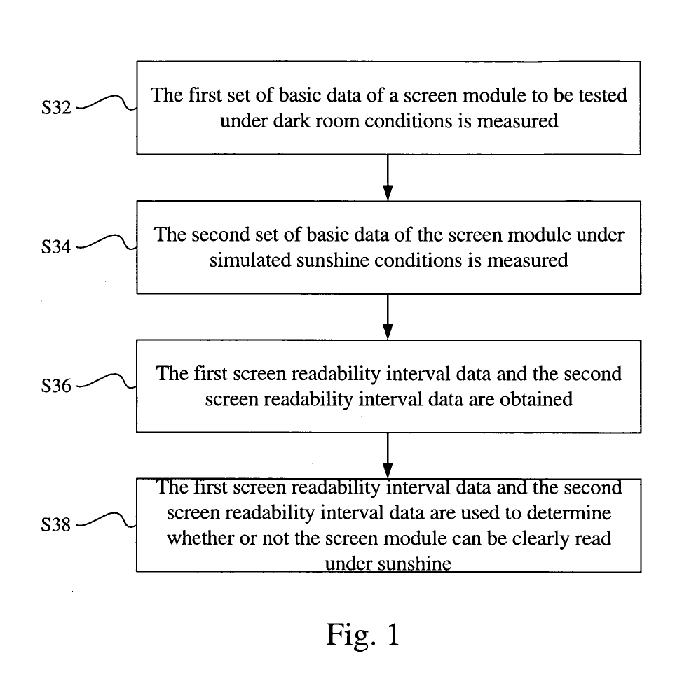

In the situation that powerful light of the sun makes human eyes unable to effectively discriminate texts on an LCD screen, the LCD screen seems to temporarily malfunction and cannot play its proper functions. The present invention adopts a new screen measurement method, and proposes a method for measuring the readability of a screen under sunshine to cope with the above drawback. As shown in FIG. 1, this method comprises the following steps. First, a first set of basic data of a screen module to be tested under dark room conditions is measured (Step S32). The first set of basic data includes brightness data (contrast ratio) when the frame of the screen module is black and white, brightness data when the frame of the screen module is a first set of color bars or a second set of color bars, and brightness data when the frame of the screen module is a first set of patterns or a second set of patterns, all under dark room conditions. The first set of color bars or the second set of color bars includes ‘RED’, ‘Green’ and ‘Blue’ (i.e., the three primary colors of light) color bars, and white color bars and black color bars. The first set of patterns or the second set of patterns is composed of fonts, lines or dots.

In this embodiment, the screen module to be tested is an LCD screen module of a resolution mode of VGA (640×480 pixels), SVGA (800×600 pixels), XGA (1024×768 pixels) or another resolution mode.

Next, a second set of basic data of the screen module under simulated sunshine conditions is measured (Step S34). The distance between a light source of the simulated sunshine conditions and the screen module is a brightness meter measures 100-cm. brightness of the simulated sunshine conditions. The simulated sunshine conditions make the brightness on the screen module to be 5000˜20000 cd/m².

The second set of basic data includes brightness data (contrast ratio) when the frame of the screen module is black and white, brightness data when the frame of the screen module is a first set of color bars or a second set of color bars, and brightness data when the frame of the screen module is a first set of patterns or a second set of patterns, all under simulated sunshine conditions.

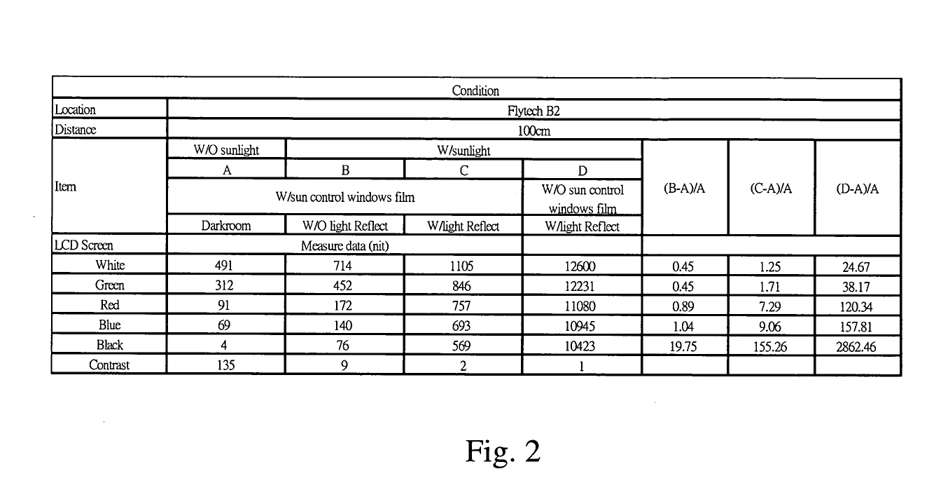

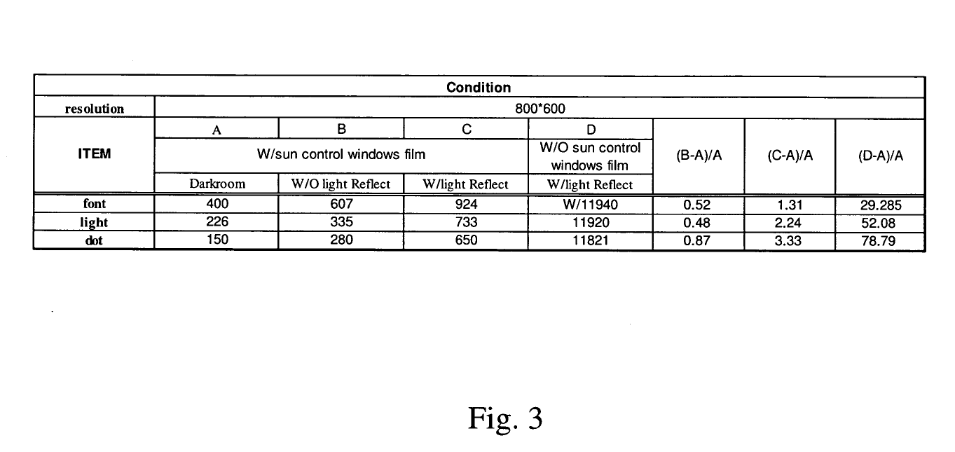

The first set of color bars or the second set of color bars includes ‘RED’, ‘Green’ and ‘Blue’ (i.e., the three primary colors of light) color bars, and white color bars and black color bars. The first set of patterns or the second set of patterns is composed of fonts, lines or dots. When measuring the first set of color bars or the second set of color bars, the screen module is provided with a polarizer. Reference is also made to both FIG. 2 and FIG. 3. FIG. 2 is a table showing measured data of color bars under dark room conditions and simulated sunshine conditions of the present invention. FIG. 3 is a table showing measured data of patterns under dark room conditions and simulated sunshine conditions of the present invention.

The contrast ratio is a ratio of the brightness of the brightest dot and the darkest dot on the screen. The larger the contrast ratio, the clearer the representation. A larger contrast ratio makes the distinction between black and white clearer, makes images more stereoscopic, and makes colors more vivid and saturated. On the contrary, a low contrast ratio makes colors poor, and makes images dull. Under simulated sunshine conditions, the range in which images can be clearly displayed and accepted by human eyes is the range of readability.

Subsequently, the first set of basic data and the second set of basic data are used to obtain a first screen readability interval data and a second screen readability interval data. The first screen readability interval data is obtained by using the first set of basic data and the second set of basic data to find out the relationship between different colors and brightness. The second screen readability interval data is obtained by using the first set of basic data and the second set of basic data to find out the relationship between the first set of patterns or the second set of patterns and brightness.

Finally, the first screen readability interval data and the second screen readability interval data are used to determine whether the screen can be clearly read under sunshine. The situation in which the screen module is readable is when the screen module is placed under dark room conditions or when there is no reflection from the polarizer in the screen module under simulated sunshine conditions. These readability interval data can be used as a basis for leave-factory quality inspection of screens.

In this embodiment, how data of color bars, data of patterns, and contrast ratio of the screen module are measured will be illustrated below.

Color Bar:

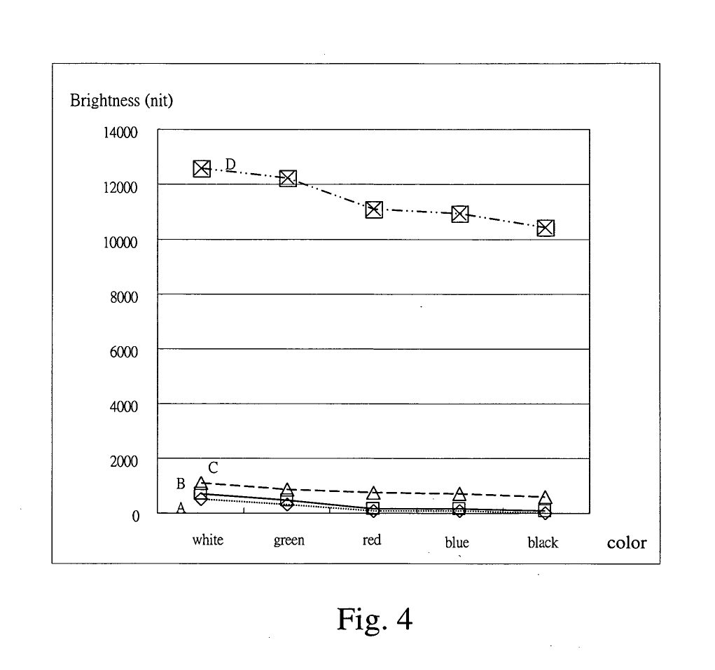

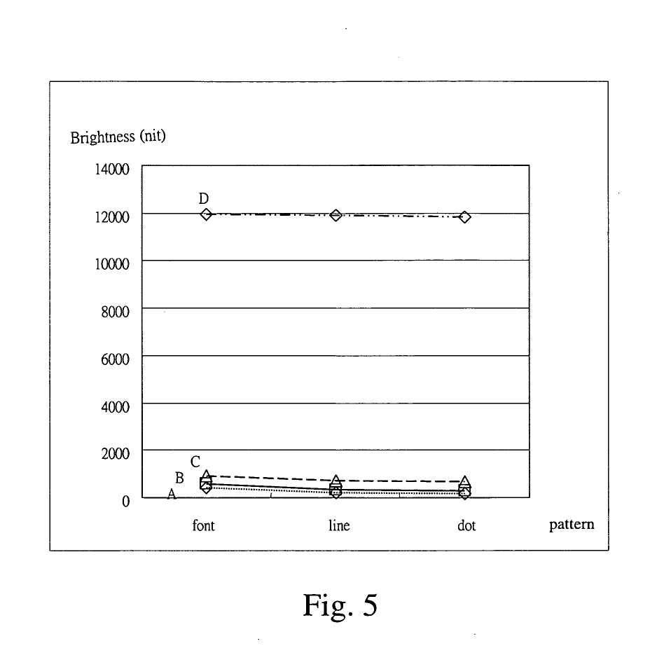

The measured data in FIG. 2 and FIG. 3 are converted to the graphs of FIG. 4 and FIG. 5, respectively. The meanings of symbols in FIG. 4 are listed below.

| | |
|---|---|
| Line A | Interval with readability |
| (the first basic data line) | |
| Line B | |
| (the second basic data | |
| line) | |
| Line C | Interval with no |
| (the second basic data | readability |
| line) | |
| Line D | |
| (the second basic data | |
| line) | |

Contrast Ratio:

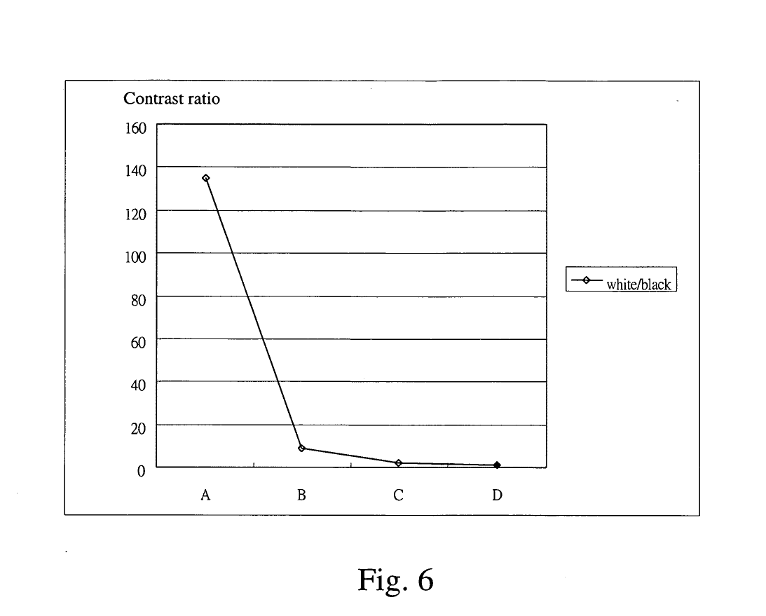

Point A and Point B in FIG. 6 represent parts that can be discriminated by human eyes and have readability. Point C and Point D have no readability because of too low contrast ratios.

Pattern:

Line A, Line B, Line C and Line D in FIG. 5 are the same as those defined in the above color bar graph (FIG. 4). Similarly, Line A and Line B in FIG. 5 represent parts that can be discriminated by human eyes and have readability. Line C and Line D represent parts that cannot be discriminated by human eyes and have no readability.

To conclude, the above examples show that the situation in which a screen module to be tested is readable is when the screen module is placed under dark room conditions or when there is no reflection from the polarizer in the screen module under simulated sunshine conditions.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A method for measuring readability of a screen comprising the steps of:
measuring a first set of basic data of a screen module to be tested under dark room conditions;
measuring a second set of basic data of said screen module under simulated sunshine conditions;
using said first set of basic data and said second set of basic data to obtain a first screen readability interval data;
using said first set of basic data and said second set of basic data to obtain a second screen readability interval data; and
using said first screen readability interval data and said second screen readability interval data to determine whether or not said screen module is clearly read under sunshine.

2. The method as claimed in claim 1, wherein said first set of basic data or said second set of basic data includes brightness data (contrast ratio) when frame of said screen module is black and white, brightness data when frame of said screen module is a first set of color bars or a second set of color bars, and brightness data when frame of said screen module is a first set of patterns or a second set of patterns.

3. The method as claimed in claim 2, wherein said first screen readability interval data is obtained by using said first set of basic data and said second set of basic data to find out relationship between different colors and brightness.

4. The method as claimed in claim 2, wherein said second screen readability interval data is obtained by using said first set of basic data and said second set of basic data to find out relationship between said first set of patterns or said second set of patterns and brightness.

5. The method as claimed in claim 2, wherein said first set of patterns or said second set of patterns is composed of fonts, lines or dots.

6. The method as claimed in claim 1, wherein said screen module to be tested is an LCD screen module.

7. The method as claimed in claim 2, wherein said first set of color bars or said second set of color bars includes white color bars, black color bars, blue color bars, green color bars and red color bars.

8. The method as claimed in claim 1, wherein brightness of said simulated sunshine conditions is 5000˜20000 cd/m².

9. The method as claimed in claim 1, wherein brightness of said simulated sunshine conditions is measured by a brightness meter.

10. The method as claimed in claim 2, wherein it is 100 cm between light sources of said simulated sunshine conditions and said screen module.

11. The method as claimed in claim 2, wherein said screen module to be tested is provided with a polarizer when measuring said first set of color bars or said second set of color bars.

12. The method as claimed in claim 1, wherein resolution of said screen module to be tested is 800×600.

13. The method as claimed in claim 11, wherein said screen module to be tested is readable when placed under dark room conditions or when there is no reflection from said polarizer in said screen module under simulated sunshine conditions.
